(19) United States
(12) Patent Application Publication
(10) Pub. No.: US 2020/0085233 A1
(43) Pub. Date: Mar. 19, 2020

(54) A METHOD FOR OPERATING A DRINKS PREPARATION MACHINE, DRINKS PREPARATION MACHINE AND METHOD FOR OPERATING AN OPERATING APPLIANCE

(71) Applicant: Tchibo GmbH, Hamburg (DE)

(72) Inventors: Doreen Hartmann, Görlitz (DE); Hosun Lee, Hamburg (DE)

(21) Appl. No.: 16/471,801

(22) PCT Filed: Dec. 19, 2017
(86) PCT No.: PCT/EP2017/083617

§ 371 Date: Jun. 20, 2019

(30) Foreign Application Priority Data
Dec. 23, 2016 (EP) 16206669.0

(51) Int. Cl. A47J 31/52; A47J 31/40; A47J 31/44; G07F 13/06; G07F 17/00

(52) U.S. Cl. CPC A47J 31/521; A47J 31/407; A47J 31/5251; G07F 17/0078; A47J 31/5255; A47J 31/4457; G07F 13/065; A47J 31/5253

(57) ABSTRACT

A method for operation of a drinks preparation machine, for producing a total product amid the use of a portion package, includes the following steps, which are carried out by the drinks preparation machine: a receiving step for receiving, by way of the communication unit, an activation command; an examination step for examining whether the drinks preparation machine is ready for producing the total product; and, if the drinks preparation machine is ready for producing the total product; a confirmation step for sending, by way of the communication unit, a confirmation that the activation command has been received and the drinks preparation machine is ready for producing the total product; a production step for producing the total product.

### BACKGROUND OF THE INVENTION

### Field of the Invention

The invention relates to drinks preparation machines for preparing drinks or the like from a portion package with a portion packaging (for example capsule) and with an extraction material (for example coffee) which is contained in the portion packaging. In particular, it relates to a method for the operation of a drinks preparation machine, to a drinks preparation machine and to a method for the operation of an operating appliance.

### Description of Related Art

Drinks preparation machines for preparing drinks or the like from an extraction material, which is present in a portion package, are known, for example, as coffee machines or espresso machines. In many corresponding systems, the portion packaging is designed as capsules, in which the extraction material is sealed, for example in an airtight manner. For extraction, the capsule is placed in a capsule receiver and is pierced, for example at two sides that are opposite to one another. An extraction fluid—generally hot water—is then introduced at the first side. The extraction product is discharged from the capsule at the second side. This takes place in a so-called brewing module.

Apart from a brewing module, one or more further units for delivering and adding a further drinks component such as, for example, milk can be present. The drinks preparation machine can therefore create a drink or generally speaking a total product of two part-products.

The European patent application No. 15 194 735 describes a method for the operation of a drinks preparation machine for creating a product of several part-products, wherein quantity shares of the part-products can be adapted by a user on a graphic display of the quantity shares.

The European patent application No. 15 194 667 describes a method for the operation of a drinks preparation machine whilst using preparation parameters that are determined by way of a portion code of a portion package. Herein, the individual preparation parameters are adaptable by the user.

Amongst other things, the option of a communication of the drinks preparation machine with an operating appliance which can be mobile and portable, for example a mobile telephone or smartphone, is described in the aforementioned patent applications. By way of the operating appliance, preparation prescripts or recipes can be transferred (transmitted) to the drinks preparation machine, or preparation prescripts that are stored in the drinks preparation machine can be modified. One envisages the preparation being activated by an operating step, which is carried out by the user at the drinks preparation machine itself.

### SUMMARY OF THE INVENTION

One possible object of the invention is to realise an operation of the drinks preparation machine that is comfortable for the user and at the same time is reliable and to provide a corresponding method for the operation of a drinks preparation machine, a drinks preparation machine and a computer program, which permit this realisation.

A further possible object of the invention is to simplify the operation of the drinks preparation machine for the user.

The method for operation of a drinks preparation machine serves for producing a total product amid the use of a portion package. Herein, the drinks preparation machine includes a communication unit that is designed for wireless communication. The method includes the following steps, which are carried out by the drinks preparation machine:
a receiving step for receiving, by way of the communication unit, an activation command;
an examination step for examining whether the drinks preparation machine is ready for producing the total product;
   and, if the drinks preparation machine is ready for producing the total product:
a confirmation step for sending, by way of the communication unit, a confirmation that the activation command has been received and the drinks preparation machine is ready for producing the total product;
a production step for producing the total product.

The activation command, which is received in the receiving step, can be sent from an operating appliance, which is separate from the drinks preparation machine, via a wireless communication connection. The operating appliance can be a mobile telephone or smartphone or another type of portable device with input means and output means, for example with a graphic user interface and with mechanical keys and/or a touchscreen.

The activation command can be an individual message (piece of information), which is transferred from the operating appliance to the drinks preparation machine or to its communication unit. Herein, the activation command can be transferred in an encoded manner. This can be effected with an unchanging key or with a changing key, for example a rotating key.

The activation command can alternatively also be transferred by way of a bidirectional exchange of messages between the operating appliance and the drinks preparation machine or its communication unit. Herein, one can use a cryptographic protocol, with which an authentication of the operating appliance and/or of the user is carried out, and only after a successful authentication is the activation command accepted and the further steps carried out after the receiving step.

As described above, the confirmation step can be carried out first of all and then the production step, or these two steps can be carried out in the reverse sequence or carried out simultaneously.

The portion package can be a capsule. This can be filled with an extraction material, for example with coffee.

The total product can consist of one or more part-products. If the total product is a coffee variant, then the part-products can be coffee, milk, milk froth, sugar, etc. These in turn are produced from components such as water, a portion package with extraction material (coffee powder), milk, etc.

In embodiments, the examination step includes one or more of the following sub-examination-steps for examining the presence of components of the total product:
examining whether a portion package is present;
examining whether a portion package for producing the total product is present;
examining whether a minimum quantity of water is present;
examining whether a sufficient quantity of water is present for producing a drink as a total product.

With the examination as to whether a portion package is present, one can control whether a portion package is present at all. The fact that a portion package is present can mean that a portion package, in a basic unit of the drinks preparation machine, is inserted, for example, into a capsule receiver, in which an extraction takes place for producing at least one component of the total product. Alternatively, it can mean that a portion package is inserted into a feed of the drinks preparation machine, from which it can be automatically transported into the capsule receiver.

The examining of the presence of a portion package is effected, for example, with a presence detector, or with a capsule recognition as is described in WO 2016/087190.

With the examination as to whether a portion package for producing the total product is present, one can control whether a portion package of the correct category is present. For example, a cleaning capsule must not be present if a drink is to be produced. This has the advantage that the production method can be terminated and the user informed if the production of the total product is not possible.

In embodiments, the examination step includes one or more of the following sub-examination-steps:
examining whether a supplementary unit for feeding a part-product, in particular milk, to the total product, is connected to the drinks preparation machine and is operationally ready;
examining whether a sufficient quantity of the part-product in particular milk is present. This “sufficient quantity” can be a minimum quantity, which is independent of the total product to be manufactured, or can be dependent on this.

Herewith, the presence and/or operational readiness of a removable supplementary unit can be controlled in the case that the drinks preparation machine includes such a supplementary unit. This has the advantage that the ability of the total product to be produced can be examined in the case of a configurable drinks preparation machine with one or more optional supplementary units.

The examination of the presence of a supplementary unit can be effected as is described in WO 2016/046237, WO 2016/046238, WO 2016/046239 and/or WO 2016/046240.

In embodiments, this examination step concerning the supplementary unit is only carried out if a preparation prescript, to which the activation command relates, demands the presence of the supplementary unit.

In embodiments, the examination step includes one or more of the following sub-examination-steps for examining an operating state of the drinks preparation machine:
examining whether the drinks preparation machine is ready for producing the total product;
examining whether no error messages of the drinks preparation machine are present;
examining whether a receptacle for receiving the total product is present;
examining whether a volume of the receptacle is compatible with the preparation prescript.

This examination step can also examine a supplementary unit of the drinks preparation machine. In further embodiments, operational parameters of the drinks preparation machine or of a supplementary unit can be examined, for example a temperature of a receptacle, a filling level of a receptacle, etc.

The examination as to whether the drinks preparation machine is ready for producing the total product can include an examination as to whether a descaling cycle or a cleaning program is not to be carried out, as to whether the drinks preparation machine is not already in operation for production of a product, etc.

The examination as to whether the drinks preparation machine is ready for producing the total product can include an examination as to whether the last production of the total product has been activated by an activation command that has been received by way of the communication unit and whether no action by the user on the drinks preparation machine itself has been carried out since then. The drinks preparation machine only carries out an activation command, which is received in a wireless manner if, since the last activation command that was received in a wireless manner, at least one action has been carried out by the user on the drinks preparation machine itself. Herewith, one can prevent a production from being repeatedly activated—whether by accident or deliberately—without the user having the opportunity of ascertaining this.

Such an action can very simply be the insertion of a new capsule or the manual ejection of the spent capsule, or an action on the physical operating unit of the machine. If an automatic detection of a receptacle is present, then the placing or removal of a receptacle can herewith be detected as an action on the drinks preparation machine.

The examination as to whether no error messages of the drinks preparation machine are present can include an examination as to whether a capsule container for receiving spent portion packages is full, whether a drip tray is full, whether—if present—a lever of a manually operated drinks preparation machine is in an opened position, whether a motorically driven unit, for example a brewing unit, is jammed, etc.

The examination as to whether a receptacle for receiving the total product is present can include an examination as to whether the receptacle is arranged below an outlet of a feed (supply) for filling the receptacle. This can be effected with one or more sensors which compliment one another and are of the following type: an infrared sensor, an ultrasound sensor, a light barrier, a weight measurement, etc.

The examination as to whether a volume of the receptacle is compatible with the preparation prescript can include an examination as to whether the volume is larger than or the same as the quantity of the total product which is to be produced according to the preparation prescript. Herein, a determining of the volume of the receptacle can be effected, for example, by way of one or more standardised receptacles of different types being defined and the type of receptacle being able to be automatically determined on the basis of a characteristics of the receptacle, the characteristics unambiguously defining the type. This characteristics can be a height or an empty weight of the receptacle, or a combination of these. The characteristic can also be defined by an optically or wirelessly recognisable identifier on the receptacle.

In embodiments, the examination step includes one or more of the following sub-examination-steps in accordance with a preparation prescript, to which the activation command relates:
examining whether an identity or a category of a portion package, the portion package being ready in the drinks preparation machine for producing the total product, is consistent with the preparation prescript;
examining, for at least one component of the total product, whether a sufficient quantity of this component is present for the production of the total product in accordance with the preparation prescript.

This preparation prescript, to which the activation command relates, can be received together with or shortly before or after the activation command in the drinks preparation machine. The preparation prescript and the activation command can be assigned to one another, for example by way of common identification information or by a reference to the preparation prescript, the reference being contained in the activation command.

The preparation prescript can specify a category of a portion package, for example a certain type of coffee (for example “espresso” or “coffee”) and additionally also an identity within a category, for example a certain coffee mixture.

In embodiments, if the identity or the category of the portion package is not consistent with the preparation prescript, a respective message is sent via the communication unit. Herewith, a corresponding indication can be displayed on the operating appliance after receiving this message. Furthermore, the user, by way of an indication on the operating appliance, can be requested to either confirm the production despite the inconsistency or to adapt the preparation prescript or to exchange the portion package.

In embodiments, the method includes the following steps, which are carried out by the drinks preparation machine, should the drinks preparation machine not be ready for producing the total product:
an error information step for sending, by way of the communication unit, error information that the activation command has been received and the drinks preparation machine is not ready for producing the total product.

In embodiments, the error information includes information on the type of error that is determined on the basis of a result of the examination step.

Depending on the type of error information, according to embodiments:
it can be displayed on the operating appliance that an error is present and the production is not carried out (“error prevents production”); and/or
information on the type of error can be displayed on the operating appliance (“wrong capsule inserted”); and/or
a request for remedying the error can be displayed on the operating appliance (“exchange capsule by capsule of the sort XY”).

Alternatively or additionally, such information can also be displayed on an operating unit of the drinks preparation machine.

In embodiments, the manufacturing step is carried out with a temporal delay that can be specified (in particular on the operating appliance by a user), in particular with a temporal delay that is specified by a message that is received via the communication unit.

The temporal delay can relate to a point in time of the receiving of the activation command. Alternatively, it can also relate to another point in time in the course of the method, for example to the point in time of the sending of the confirmation, or to the point in time of the completion of the examination step.

The temporal delay can be effected by way of the specification of an absolute time, thus a clock time, or a relative time (“in ten minutes”) relative to the point in time of that of the receiving step or the confirmation step. The temporal delay can also be specified as part of the activation command, or in a separate message. This separate message, in turn, can be received before or after the receiving step.

Herewith, the production can be activated at a later point in time, which is desired by the user.

In embodiments, an examination as to whether a user carries out an input at the drinks preparation machine in order to terminate the method and the production is carried out before the production step. For example, a display of the drinks preparation machine can be activated during a certain time interval, for example five seconds. The display can be assigned to an operating element that corresponds to a drinks volume or to a receptacle size of the total product to be manufactured. For example, the display is a light means of a button of the operating unit. If an operating action is carried out and detected at the drinks preparation machine within the mentioned time interval, then the method is interrupted and the production does not take place. If no operating action is carried out, then the manufacture is carried out. Herewith, a user can actively terminate the production, for example if he recognises that the selected receptacle size is incorrect or no receptacle is present.

In embodiments, the method as a further step includes: a completion confirmation step for sending, by way of the communication unit, a completion confirmation that the production of the total product is completed. Herewith, after receiving the completion confirmation, by way of the operating appliance it can be displayed to the user that the total product is ready for consumption.

In embodiments, the method as a further step includes: a production error message step for sending, by way of the communication unit, a production error message that an error has occurred on producing the total product. Herewith, after receiving the production error message, by way of the operating appliance it can be displayed to the user that an error has occurred. Instructions for the diagnosis and/or remedying of the error can subsequently be displayed on the operating appliance and/or on an operating unit of the drinks preparation machine.

In embodiments, the method includes the following steps, which are carried out by the drinks preparation machine:
storing a preparation prescript, to which the activation command relates, in the drinks preparation machine;
producing the total product according to the stored preparation prescript at a later point in time, in particular after receiving an error remedying message in the drinks preparation machine.

Herewith, after a remedying of the error, the preparation can be activated again without the preparation prescript (thus a recipe) having to be transferred to the drinks preparation machine afresh for this.

The error remedying message can be received via the operating appliance and the communication unit, or however also by an operating unit of the drinks preparation machine. The error remedying message can be activated by the operating appliance or the operating unit, after a corresponding user input has taken place. Typically, the examination step can be carried out afresh subsequently to the receiving of the error remedying message. The examination step, in particular that which has led to the error information step, can also be periodically repeated, so that after remedying the error by the user, the error remedying message is automatically activated without further input of the user.

In embodiments, the method includes the following steps, which are carried out by the drinks preparation machine:
storing a preparation prescript, to which the activation command relates, in the drinks preparation machine;
receiving a modified preparation prescript, or receiving data describing changes of the stored preparation prescript and herewith defining a modified preparation prescript;
a renewed implementation of the receiving step and of the examination step whilst taking into account the modified preparation prescript; and
   if the drinks preparation machine is ready for producing the total product:
of the confirmation step and
of the production step.

Herewith, after an error remedying notice, it is possible for the user to modify the preparation prescript—for example since it is inconsistent with the identity or category of the portion package—and to activate the preparation anew. Data describing changes of the stored preparation prescript are, for example, individual parameters that replace corresponding parameters of the stored preparation prescript.

In embodiments, the method includes the following steps, which are carried out before the receiving step:
inputting an activation decision by a user;
displaying a cancellation option on the operating appliance, in particular during a predefined time duration;
if a cancellation decision is inputted by the user, terminating the method; or if no cancellation decision is inputted by the user, continuation of the method.

This continuation of the method therefore leads to the transfer of the activation command from the operating appliance and to the receiving of the activation command by the communication unit, and the further steps: examination step, as well as confirmation step and production step or error information step, etc. The examination step can already be carried out during the displaying of a cancellation option on the operating appliance.

The activation decision is therefore a user input, typically on the operating appliance. According to these embodiments, this therefore does not directly lead to the sending of the activation command to the drinks preparation machine, but not until after the display of the cancellation option and in particular after completion of the predefined time duration.

By way of the cancellation option, the user—for a limited time duration—is given the opportunity of stopping the production. In contrast to a confirmation request (such as “do you really wish to activate the production”) which needs to be actively acknowledged by the user, here no further action of the user is necessary in the normal case.

The drinks preparation machine is designed, in particular programmed, to carry out the method according to one of the preceding claims.

The method for operation of an operating appliance for interaction with a user and for wireless communication with a drinks preparation machine includes the following steps, which are carried out by the operating appliance:
sending an activation command in the case that a user carries out an input of an activation decision at the operating appliance;
receiving a confirmation that the activation command was received, with information as to whether the drinks preparation machine is ready for producing a total product;
displaying a confirmation indication on the operating appliance, in accordance with the received confirmation.

In embodiments, the method includes the following steps, which are carried out by the operating appliance:
receiving error information;
displaying an error indication on the operating appliance in accordance with the received error information.

In embodiments, the method includes the following steps, which are carried out by the operating appliance:
sending a message that specifies a temporal delay for carrying out a production step.

In embodiments, the method includes the following steps, which are carried out by the operating appliance:
receiving a completion confirmation;
displaying a completion confirmation indication that the production of the total product is completed, on the operating appliance.

In embodiments, the method includes the following steps, which are carried out by the operating appliance:
receiving a production error notice;
displaying a production error indication that an error has occurred on producing the total product, on the operating appliance.

In embodiments, the method includes the following step, which is carried out by the operating appliance:
sending a modified preparation prescript, or sending data describing changes of a preparation prescript and herewith defining a modified preparation prescript.

In embodiments, the method includes the following steps, which are carried out by the operating appliance:

inputting an activation decision by a user;

displaying a cancellation option on the operating appliance;

if a cancellation decision is inputted by the user, terminating the method; or, if no cancelation decision is inputted by the user, continuation of the method.

The computer program serves for the operation of an operating appliance for the interaction with a user and for wireless communication with a drinks preparation machine, wherein the computer program carries out the described method on execution on the operating appliance.

The operating appliance includes an input device and an output device, which can be combined as a touchscreen, as well as a data processing unit and a communication unit for communication with the drinks preparation machine. The operating appliance can be a mobile, in particular portable device, for example a mobile telephone or smartphone, or a functionally equivalent device such as a smart-watch or a wearable computer. The operating appliance can also be installed in a fixed manner, for example as part of a building automation facility or kitchen automation facility. Thanks to the operating appliance, operating elements, in particular the input device and output device of the operating appliance and its programmability and computation power can be utilised for activation of the drinks preparation machine.

The operating appliance can be designed for carrying out at least a part of the described method. The operating appliance communicates with the drinks preparation machine via a communication connection. Herein, typically data, which is representative of a receptacle selection or total volume, absolute or relative quantity shares and optionally further parameters of part-products, such as, for example, temperature, sequence of preparation of part-products, name of the drink, name of the user, preparation hints and recommendations, capsule preference, is transferred (transmitted) to the drinks preparation machine. Further data can be confirmation inputs that display to the system the fact that the user has carried out a displayed user instruction. Initial values for quantity shares, user instructions, etc., which are to be displayed, can be transferred from the drinks preparation machine to the operating appliance.

In an embodiment, the system includes a supplementary unit, which is designed for feeding milk as a second part-product, optionally amid the heating of the milk, as well as for forming and feeding milk froth as a third part-product to the total product.

The computer program for implementation on the operating appliance can be loaded into an internal memory of a digital processing unit of the operating appliance and includes computer program code means which, when they are carried out in the digital data processing unit of the operating appliance, bring this to carry out the steps of the aforedescribed method, which are envisaged for the operating appliance. A computer program product includes a data carrier, or a computer-readable medium, on which the computer program code means are stored.

In embodiments, the drinks preparation machine is provided with a feed unit that can automatically feed portion packages and transport them into the capsule receiver. The feed unit can be designed for the selective feeding of portion packages of different types. An automatic production of total products of different types is possible with this. Herein, on producing the total product in accordance with the preparation prescript, a matching portion package, which is to say one that is consistent with the preparation prescript, can be automatically fed.

In further embodiments with such a feed unit, several receiving steps each with an activation command and an assigned preparation prescript as a production task can be carried out in the drinks preparation machine. These steps can be stored and successively worked off in separate production steps. Optionally, after completion of a production step, a completion confirmation step is carried out in each case for notifying the user. The examination steps and confirmation steps can each be carried out before carrying out the individual productions steps. A user instruction can also be sent between production steps, in order to request the user to replace a just filled receptacle with an empty one before the beginning of a production step.

In embodiments, a programming of the production with a certain temporal delay is not accepted if the absolute time, for which the production step is to take place, lies within an interval of a predefined length—for example three minutes—before or after the absolute time for an already stored production step.

In embodiments, information that describes stored preparation prescripts or production tasks is displayed on the operating unit or on the operating appliance. Such information can be the time of the production and/or the name of the recipe. Moreover, also only the information that a stored preparation prescript or a production task is present can be displayed, for example by way of a light display, in particular an LED.

### BRIEF DESCRIPTION OF THE DRAWINGS

The subject-matter of the invention is hereinafter explained in more detail by way of preferred embodiment examples, which are represented in the attached drawings. In each case in a schematic manner are shown in:

FIG. 1 a system for drinks preparation;

FIGS. 2-3 flow diagrams of methods for the operation of the drinks preparation machine.

### DETAILED DESCRIPTION OF THE INVENTION

Basically, in the figures the same parts are provided with the same reference numerals.

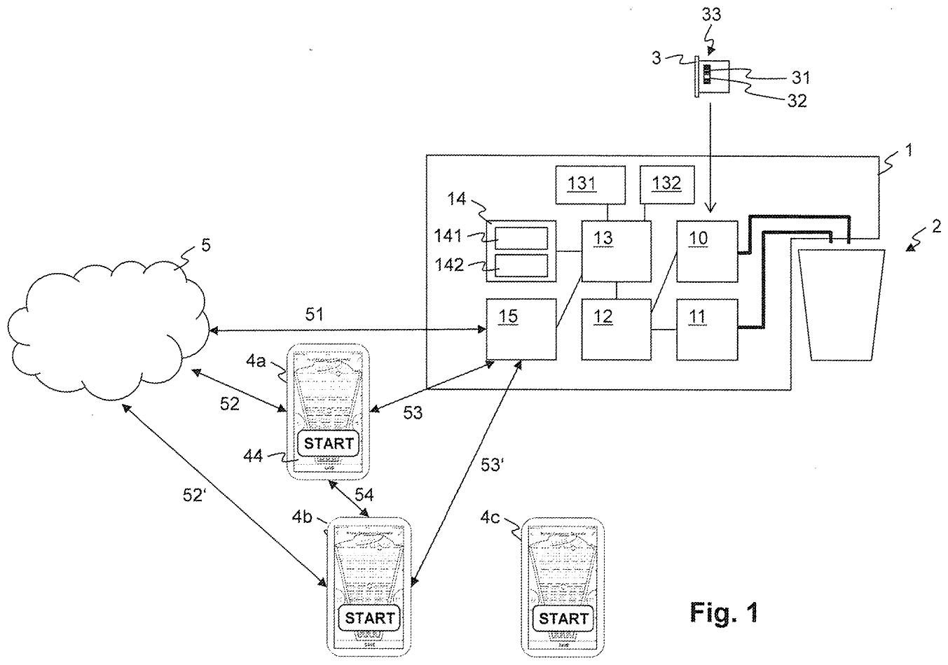

FIG. 1 shows a system for drinks preparation with a drinks preparation machine 1 for filling a receptacle 2 with at least one extraction material from a portion package 3. The drinks preparation machine 1 can be connected to a communication network 5 such as an intranet or the internet via a first communication connection 51. An operating appliance 4a, 4b, 4c, which can be mobile and portable, for example a mobile telephone or smartphone, or a dedicated device that is only provided for operation of the drinks preparation machine 1, can communicate with the drinks preparation machine 1 in an indirect manner via a second communication connection 52, 52′ and the communication network 5 or directly via a third communication connection 53, 53′. Two operating appliances 4a, 4b can communicate with one another via a fourth communication connection 54, either bidirectionally or at least unidirectionally, for example from a first operating appliance 4a to a second operating appliance 4b.

The drinks preparation machine 1 includes a base unit 10 for extracting an extraction product by way of an extraction fluid. The drinks preparation machine 1 is, for example, a portion capsule coffee machine of the type known per se, wherein the base unit 10 is a brewing module and the extraction fluid is hot water which is under pressure. The extraction product is fed to the receptacle 2

The portion package 3 includes a portion packaging (for example capsule) and an extraction material (for example, coffee) that is contained in the portion packaging.

The drinks preparation machine 1 includes a supplementary unit 11 that can deliver or produce at least one further product or part-product, for example milk and/or milk froth, which are likewise fed to the receptacle 2. The supplementary unit 11 can include heating elements and/or cooling elements for heating or cooling at least one further product.

The extraction product and the at least one part-product are fed to the receptacle 2 in a simultaneous or sequential manner and together form a total product in the receptacle 2, for example a “caffe macchiato” consisting of coffee, cold or warm milk, and cold or warm milk froth. A total product is represented schematically as consisting of a first share 21, a second share 22 and a third share 23. The shares in the receptacle 2 can be layered above one another or mixed, depending on the preparation prescript. A “share” is to be understood as a volume share or quantity share.

For the control of the base unit 10 and the supplementary unit 11, for the operation by the user and for the optional communication with other devices, the drinks preparation machine 1 includes a control unit 2, a superordinate control unit 13, an operating unit 14 and a communication unit 15.

The control unit 12 is configured for the activation of the base unit 10 and the supplementary unit 11, for example by way of it activating pumps, valves, heating elements, etc. of these units and detecting (acquiring) measured values of temperatures, pressures, flow, etc., and processing these. The function of the control unit 12 can be realised by a single physical electronic unit, for example a microcontroller, or by several physical units or microcontrollers which are each assigned to the base unit 10 and the supplementary unit 11 and communicate with one another via a communication bus or transfer individual analog or binary signals via signal leads.

The superordinate control unit 13 is configured for activating the operating unit 14 and the communication unit 15. The superordinate control unit 13 can be realised in a manner in which it is separated from the control unit physically and/or with regard to program technology, or however together with the control unit 12 can form a single unit. In this context, according to embodiments, the control unit 12 and the superordinate control unit 13 can be identical.

The operating unit 14 includes an input unit 141, for example with switches, buttons and/or a jog dial or adjusting wheel and/or a touch-sensitive surface, as well as an output unit 142 with optical display means such as lights or a screen etc. and/or acoustic display means such as a loudspeaker, summer, etc. In embodiments, the operating unit 14 includes no screen. Information concerning the programming of the drinks preparation machine 1 can then be displayed on the screen of the operating appliance 4.

The communication unit 15 is configured for communication via the first communication connection 51 which can be wireless (for example by way of Wi-Fi, Bluetooth, etc.) or wire-connected (for example, by way of Ethernet, USB), in particular for communication with the communication network 5. Furthermore, the communication unit 15 can communicate with the operating unit 4 in a wireless manner (for example by way of Wi-Fi, Bluetooth, NFC, etc.) or in a wire-connected manner (for example by way of USB). The communication unit 15 can also be configured for reading out and writing a removable portable data carrier, for example via a USB interface or SD-card interface.

One or more operating appliances 4a, 4b, 4c can be present. Such an operating appliance 4, typically a mobile telephone or smartphone includes a user interface 44, for example a touch-sensitive screen or touchscreen, which functions as an input and output unit. Additionally or alternatively, buttons (keys) of the operating appliance 4 can also serve as input units. A speech input can be realised additionally or alternatively to this.

Where not otherwise mentioned, information can be outputted to the user and inputs of the user can be inputted, via the operating unit 14 and/or the operating appliance 4. In the present description, whenever therefore interactions with the user are described, it is to be understood that this is herewith also to mean outputs or inputs by way of the operating unit 14 and/or by way of the operating appliance 4. Generalised, these can therefore be termed as an interface unit.

The superordinate control unit 13 includes a memory 131, in which amongst other things preparation prescripts or recipes are stored. A preparation prescript includes at least control information which can be converted into commands for the control of the base unit 10 and of the supplementary unit 11. Such control information on the one hand includes sequence information which specifies a sequence of steps which are to be carried out by the base unit 10 and/or supplementary unit 11 for producing a total product. On the other hand, the control information includes, for example, temperatures, volume details, time details, etc.—hereinafter generally also called preparation parameters—which parameterise a sequence.

Sequence information represents, for example, “switch on the water heating means of the supplementary unit 11; switch on the pump of the brewing module for fifteen seconds; wait for at least five seconds after switching off the pump until the heating means is at the desired temperature; switch on the milk pump for twelve seconds”. The times and temperatures that are mentioned in this example can be specified by preparation parameters and/or be determined by the control in accordance with other preparation parameters and measured values of sensors.

A preparation prescript can also include user instructions. These instructions are part of the preparation of the total product and must be carried out by a user. For this, the user instructions can be displayed by way of the output unit 142 or the user interface 44 of the operating appliance 4. For example, such user instructions are “now add ice cubes” or “please measure 20 ml of caramel syrup” or “now add the prepared caramel syrup” or “please stir” or “please examine whether the inserted capsule and selected recipe match” etc. A user instruction can be accompanied by a visual representation, for example of the total product to be created, of a selected or actually inserted capsule etc.

For preparing a product, control information or corresponding commands are implemented by the base unit 10 and the supplementary unit 11 in accordance with the preparation prescript and a preparation sequence is realised by this. If the preparation prescript includes user instructions, then these are displayed to the user at corresponding locations of the sequence. The subsequent control information of the preparation sequence is implemented after an acknowledgement by the user by way of the input unit 141 or the user interface 44, the acknowledgement confirming the implementation of the user instruction to the system.

A preparation prescript can include preparation parameters that are permitted to be adapted by the user, as well as preparation parameters that cannot be adapted by the user. Adaptable preparation parameters, for example, are (volume) shares of part-products in the total product, a total quantity or the temperature of a part-product. For adaptable preparation parameters, the preparation prescript can include a standard value or default value that is used if the user does not adapt the parameter.

For adapting adaptable preparation parameters, a selection of one or more such preparation parameters is displayed to the user on the operating unit 14 of the drinks preparation machine 1 or the user interface 44 of the operating appliance 4 and an input of the user for adapting the preparation parameter is detected. The input can be effected by way of actuating real buttons and/or virtual buttons such as keys or “buttons” in particular “arrow keys” and/or displaceable markings or “sliders” on a touchscreen of the operating unit 14 or of the operating appliance 4.

The operating unit 4 transfers information that represents the detected user inputs such as quantity shares, selection of the receptacle or total quantity, temperature selection etc., to the drinks preparation machine 1 in a direct manner via the third communication connection 53 or indirectly via the second communication connection 52 and the first communication connection 51.

The portion package 3 is provided with a machine-readable portion code 33. This can be realised by information carriers that are readable for example in an optical, mechanical or wireless manner via radio, or by a combination of two or more such information carriers. The portion code 33 represents a portion category 31 that specifies a category, to which the portion package 3 is assigned. Such categories can be different categories of drinks or products, such as “Espresso”, “normal coffee”, “filter coffee”, “tea” and also “special capsule”. The portion code 33 moreover represents a portion identity 32, to which the portion package 3 is assigned. Such identities can represent certain individual products or varieties, such as “Arabica No. 42” or “Colombia special”. Portion packages 3 with the same portion category 31 can have different portion identities 32. Portion packages 3 or corresponding products of a different identity can therefore be grouped into categories by way of the portion category 31.

An assignment of the portion code 33 or of portion categories 31 and/or portion identities 32, in each case to recommended or allowable ranges for preparation parameters can be stored in the drinks preparation machine 1. With this, after inserting a portion package 3 and on the basis of the portion code 33, one can automatically examine whether the portion package 3 is compatible with the quantity shares that are set by the user and/or whether the portion package 3 is consistent with a preparation prescript that is selected by the user, thus that this is suitable for the preparation prescript. If this is not the case, then a warning can be displayed and/or the further processing of the portion package 3 can be stopped. Alternatively, a positive message can also be generated if the selected capsule is particularly well suited for the selected quantity shares. For example, an espresso capsule is not optimally suited should a coffee quantity that is envisaged for a normal coffee be selected by the user. Also a cleaning capsule or a tea capsule is basically not suitable if the preparation of a drink with milk has been selected.

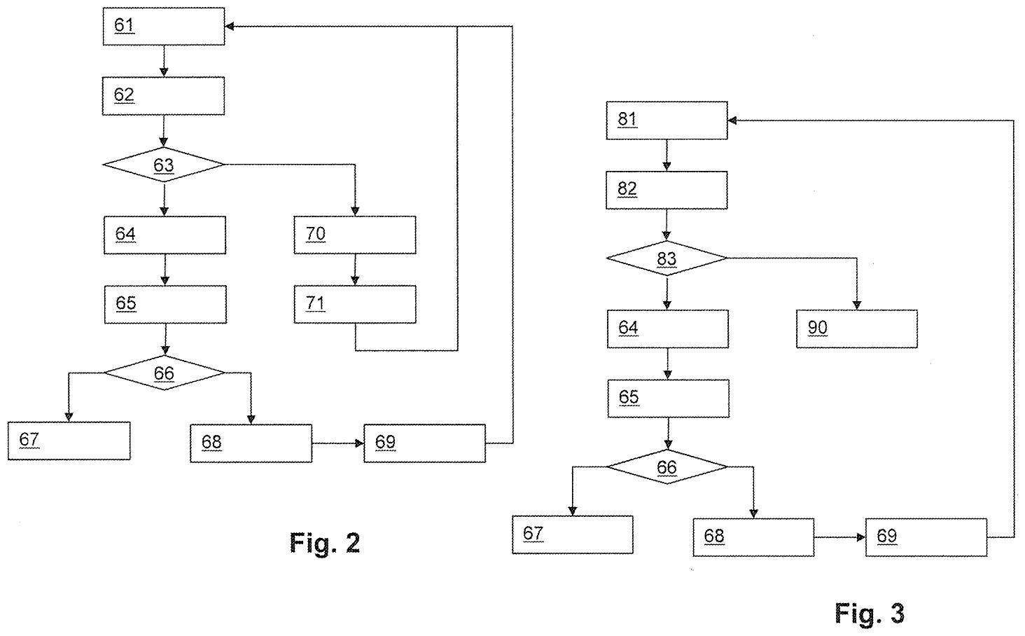

FIG. 2 shows a flow diagram of a sequence of a method for operating the drinks preparation machine 1. This method ensures the ability of a production process to be carried out. Where not stated otherwise, the steps are carried out by the drinks preparation machine itself. The steps are the following:
Receiving step 61: a wireless communication unit 15 of the drinks preparation machine 1 receives an activation command.
Examination step 62: it is examined whether the drinks preparation machine 1 is ready for producing a total product.
Branching 63, depending on whether the drinks preparation machine 1 is ready or not.
If the drinks preparation machine 1 is ready:
   Confirmation step 64 for sending, by way of the communication unit 15, a confirmation that the activation command was received and the drinks preparation machine 1 is ready for producing a total product:
   Production step 65, in which the production of the total product by the drinks preparation machine 1 takes place;
   Second branching 66, depending on whether the production has taken its course in an error-free manner.
   If the production has taken its course in an error-free manner,
      Completion confirmation step 67, in which a completion confirmation that the production of the total product is completed is sent by way of a commutation unit 15. The operating appliance 4 shows a corresponding display for the user. The implementation of the completion confirmation step 67 can be effected in various manners, for example by way of a “push” method, in which the drinks preparation machine 1 actively sends a message to the operating appliance 4, or by way of a “polling” method, in which the operating unit 4 repeatedly enquires the status of the drinks preparation machine 1
   If the production has not taken its course in an error-free manner,
      Production error message step 68, in which a production error message that an error has occurred on production of the total product is sent by way of the communication unit 15. The production error message can include information on the type of error and/or its remedying or refer to such information, which for example is stored and displayed in the operating appliance 4.
      Production error remedying step 69, in which a remedying of the error can be carried out by the user on the basis of the production error message.
      Continuation of the method with the receiving step, after the user has sent an activation command afresh by way of the operating appliance 4.
If the drinks preparation machine 1 is not ready:
   Error information step 70, in which error information is sent by the communication unit 15, with a confirmation that the activation command has been received but the drinks preparation machine 1 is not ready for producing the total product. The error information depends on the type of the examination step that has determined this. It can relate to the absence of components and/or of a supplementary unit, or to an operating state of the drinks preparation machine or to inconsistencies between the preparation prescript and the current state of the drinks preparation machine.
   Error remedying step 71, in which a remedying of the error and/or an adaptation of the preparation prescript can be carried out by the user on the basis of the error information.
   Continuation of the method with the receiving step, after the user has sent an activation command afresh by way of the operating unit 4.

FIG. 3 shows a flow diagram of a sequence of a method for operation of the drinks preparation machine 1. This method ensures the authorisation for carrying out a production process. Where not stated otherwise, the steps are carried out by the drinks preparation machine itself. The steps are the following:
Receiving step 81: a wireless communication unit 15 of the drinks preparation machine 1 receives an activation command and assigned authentication information. The authentication information can then be transferred as a key. Alternatively, the authentication information can be determined by a multi-step method amid the exchange of information between the drinks preparation machine 1 and an operating appliance 4.
Examination step 82: it is examined on the basis of the authentication information whether the activation command originates from an operating appliance 4a, 4b, 4c that is authorised for activating this certain action in the drinks preparation machine 1, in particular for the remote activation of a production. This is effected, for example, by way of determining, on the basis of the authentication information, an authorisation that is stored in the drinks preparation machine 1 and specifies whether a certain action, in particular the activation of a manufacturing step, is permitted to be activated.
Branching 83, depending on whether the operating appliance 4a, 4b, 4c is authorised or not
If the operating appliance 4a, 4b, 4c is authorised:
   Confirmation step 64 (optional), manufacturing step 65, and subsequent steps as already described with regard to FIG. 2.
If the operating appliance 4a, 4b, 4c is not authorised:
   Authorisation error step 90, in which error information that the activation command was received but the operating unit 4a, 4b, 4c is not ready for activating this certain action, in particular the remote activating of the production, is sent by the communication unit 15. This error information can be displayed at the operating appliance 4.

The method according to the FIGS. 2 and 3 can be combined with one another. For example, from FIG. 2
the examining step 62 as to whether the drinks preparation machine 1 is ready for producing the total product and
the subsequent branching 63,
   is added in FIG. 3 between
the branching 83 and
the confirmation step 64 (optional) or the production step 65.

Different stages or authorisations can be present. For example, an upper authorisation (or “administrator authorisation”) that permits a production procedure to be activated in the drinks preparation machine 1 is assigned to the first operating appliance 4a in the configuration of FIG. 1. The third operating appliance 4c does not have this authorisation, but only a “lower authorisation” or “user authorisation”. With these, preparation prescripts (recipes) can be adapted and transferred to the drinks preparation machine 1, but the activation of the production must take place at the drinks preparation machine 1 itself, i.e., by way of actuating an operating element on the operating unit 14 of the drinks preparation machine 1. With this, one can ensure that an arbitrary user cannot activate a production process in an uncontrolled manner.

A middle authorisation (or “sub-administrator”) can be assigned to the second operating appliance 4b. This middle authorisation permits the activation of the production of a product by this second operating appliance 4b.

The assignment of a middle authorisation to an operating appliance 4 can only be effected by way of an operating appliance 4, to which an upper authorisation is assigned. The first operating appliance 4a with the upper authorisation can thus assign a middle authorisation to another, for example the second operating appliance 4b. This can be realised by way of the first operating appliance 4a assigning a key or generally authentication information to the second operating appliance 4b, wherein a middle authorisation is assigned to this authentication information in the drinks preparation machine 1. This authentication information is transferred to the second operating appliance 4b from the first operating appliance 4a. For the purpose of interception protection, this is preferably effected via the fourth communication connection 54, which is a channel other than the channel, via which the operating appliances 4 communicate with the drinks preparation machine 1. This other channel is preferably only designed for transfer in the near-range, for example according to an NFC standard or Bluetooth standard, in contrast to a Wi-Fi standard for communication with the drinks preparation machine 1. The other channel can also be unidirectional, for example by way of an optical signal such as a barcode or Morse code that is outputted from the first operating appliance 4 and is received or scanned by the second operating appliance 4b. An acoustic signal can also be used as a unidirectional signal. The information, which is transferred (transmitted) by the signal, can be modulated for example onto a carrier signal, in particular by way of modulation in the frequency range and/or modulation in the time range. Amongst these are multi-frequency code methods. The acoustic signal can be produced via a loudspeaker or vibration element. A vibration element or a vibration alarm can be a motor with a rotating mass with an imbalance.

The authentication information, which is assigned to the second operating appliance 4b, can be unambiguous for each of the operating appliances 4:
either as a combination of a common administration key with an individual identification key which each only identifies the operating appliance 4 but does not correspond to an authorisation. One can then examine whether the administration key is valid for the drinks preparing machine 1, for determining the authorisation for activating a production process in the drinks preparation machine 1. The identification key is then used for determining whether an operating appliance 4a has an upper authorisation. On configuring the drinks preparation machine 1, one can specify that it is exclusively the first operating appliance 4a which has this upper authorisation which is used for configuring. Then, for issuing a middle authorisation, only the administrator key can be transferred to the second operation device 4b. Since the second operating unit 4b has a different identification key than the first, consequently it can have no upper authorisation and cannot modify any authorisations.
Or a combined key, which codes the identity as well as the authorisation of an operating appliance 4, can be present. An authorisation, which specifies the authorisation for activating a production process and also that for issuing (middle) authorisations to other operating appliances 4, is then assigned to each combined key in the drinks preparation machine 1. The combined key is then transferred to the second operating appliance 4b on issuing a middle authorisation, and the assignment of the combined key with a middle authorisation is stored in the drinks preparation machine 1.

Generally, it is the case that the different keys or authentication information is not sent from the first operating appliance 4a and must be produced in this. What is relevant is the fact that the authentication information is shared. Herein, the generation of a key pair of a private and public key is also indicated “sharing the authentication information”.

The transfer of authentication information can also be effected via a public communication network 5 amid the use of suitable cryptographic methods.

1. A method for operation of a drinks preparation machine, for producing a total product amid the use of a portion package, wherein the drinks preparation machine comprises a communication unit, which is designed for wireless communication, wherein the method comprises the following steps which are carried out by the drinks preparation machine:
a receiving step for receiving, by way of the communication unit, an activation command;
an examination step for examining whether the drinks preparation machine is ready for producing the total product;
and, if the drinks preparation machine is ready for producing the total product:
a confirmation step for sending, by way of the communication unit, a confirmation that the activation command has been received and the drinks preparation machine is ready for producing the total product;
a production step for producing the total product.

2. The method according to claim 1, wherein the examination step comprises one or more of the following sub-examination-steps for examining the presence of components of the total product:
examining whether a portion package for the production of the total product is present;
examining whether a minimum quantity of water is present.

3. The method according to claim 1, wherein the examination step comprises one or more of the following sub-examination-steps:
examining whether a supplementary unit for feeding a part-product to the total product, is connected to the drinks preparation machine and is operationally ready;
examining whether a sufficient quantity of the part-product is present.

4. The method according to claim 1, wherein the examination step comprises one or more of the following sub-examination-steps for examining an operating state of the drinks preparation machine:
examining whether the drinks preparation machine is ready for producing the total product;
examining whether no error messages of the drinks preparation machine are present.

5. The method according to claim 1, wherein the examination step comprises the following sub-examination-step for examining an operating state of the drinks preparation machine:
examining whether a receptacle for receiving the total product is present.

6. The method according to claim 1, wherein the examination step comprises one or more of the following sub-examination-steps in accordance with a preparation prescript, to which the activation command relates:
examining whether an identity or a category of a portion package, said portion package being ready in the drinks preparation machine for producing the total product, is consistent with the preparation prescript;
examining, for at least one component of the total product, whether a sufficient quantity of this component is present for the production of the total product in accordance with the preparation prescript.

7. The method according to claim 1, which comprises the following steps which are carried out by the drinks preparation machine, should the drinks preparation machine not be ready for producing the total product:
an error information step for sending, by way of the communication unit, error information that the activation command has been received and the drinks preparation machine is not ready for producing the total product.

8. The method according to claim 1, wherein the production step is carried out with a specifiable temporal delay after the receiving step or after the confirmation step, in particular with a temporal delay which is specified by a message which is received via the communication unit.

9. The method according to claim 1, comprising, as a further step, a completion confirmation step for sending, by way of the communication unit, a completion confirmation that the production of the total product is completed.

10. The method according to claim 1, comprising, as a further step, a production error message step for sending, by way of the communication unit, a production error message that an error has occurred on producing the total product.

11. The method according to claim 1, which comprises the following steps which are carried out by the drinks preparation machine:
storing a preparation prescript, to which the activation command relates, in the drinks preparation machine;
producing the total product according to said stored preparation prescript at a later point in time, in particular after receiving an error remedying message in the drinks preparation machine.

12. The method according to claim 1, which comprises the following steps which are carried out by the drinks preparation machine:
storing a preparation prescript, to which the activation command relates, in the drinks preparation machine;
receiving a modified preparation prescript, or receiving data describing changes of the stored preparation prescript and herewith defining a modified preparation prescript;
a renewed implementation of the receiving step and examination step whilst taking into account the modified preparation prescript; and
if the drinks preparation machine is ready for producing the total product:
of the confirmation step and
of the production step.

13. The method according to claim 1, comprising the steps which are carried out before the receiving step:
inputting an activation decision by a user;
displaying a cancellation option on the operating appliance;
if a cancellation decision is inputted by the user, terminating the method; or if no cancellation decision is inputted by the user, continuation of the method.

14. A drinks preparation machine, designed to carry out the method according to claim 1.

15. A method for operation of an operating appliance for interaction with a user and for wireless communication with a drinks preparation machine, wherein the method comprises the following steps which are carried out by the operating appliance:
sending an activation command in the case that a user carries out an input of an activation decision at the operating appliance;
receiving a confirmation that the activation command has been received, with information as to whether the drinks preparation machine is ready for producing a total product;
displaying a confirmation indication on the operating appliance, in accordance with the received confirmation.

16. The method according to claim 15, comprising the following steps which are carried out by the operating appliance:
receiving error information;
displaying an error indication on the operating appliance in accordance with the received error information.

17. The method according to claim 15, comprising the following step which is carried out by the operating appliance:
sending a message which specifies a temporal delay for carrying out a production step.

18. The method according to claim 15, comprising the following step which is carried out by the operating appliance:
sending a modified preparation prescript, or sending data describing changes of a preparation prescript and herewith defining a modified preparation prescript.

19. The method according to claim 15, comprising the following steps which are carried out by the operating appliance:
inputting an activation decision by a user;
displaying a cancellation option on the operating appliance;
if a cancellation decision is inputted by the user, terminating the method; or, if no cancellation decision is inputted by the user, continuation of the method.

20. A computer program for the operation of an operating appliance for the interaction with a user and for wireless communication with a drinks preparation machine, wherein the computer program carries out, on execution on the operating appliance, the method according to claim 14.
